(19) United States
(12) Patent Application Publication
(10) Pub. No.: US 2026/0211679 A1
(43) Pub. Date: Jul. 23, 2026

(54) Verfahren und Vorrichtung zur Durchführung einer Mehrzahl von Computerprogrammen auf einer Datenverarbeitungsanlage

(71) Applicant: Deutsches Zentrum für Luft- und Raumfahrt e.V., Bonn-Oberkassel (DE)

(72) Inventor: Wanja ZAESKE, Braunschweig (DE)

(21) Appl. No.: 19/413,631

(22) Filed: Dec. 9, 2025

(30) Foreign Application Priority Data
Dec. 13, 2024 (DE) 10 2024 137 609.0

(51) Int. Cl. G06F 9/30; G06F 9/455

(52) U.S. Cl. CPC G06F 9/30145; G06F 9/4552

(57) ABSTRACT

The invention relates to a method for running a plurality of computer programs on a data processing system that has at least two separate computing units which share a common resource of the data processing system, wherein each computer program is run on one of the computing units of the data processing system using byte code as a program code means by transcoding the program code means of the respective computer program, provided as byte code, into the relevant machine commands for the computing units by means of a transcoder of the data processing system, characterized in that for each computer program, the transcoder identifies at least one interference value as a function of a number of transcoded machine commands per time step.

The invention relates to a method for running a plurality of computer programs on a data processing system that has at least two separate computing units which share a common resource of the data processing system. The invention also relates to an associated computer program.

The invention also relates to a data processing system that has at least two separate computing units which share a common resource of the data processing system.

In the field of aviation, computer systems are increasingly used to support pilots in steering the flying object and, where applicable, even autonomously steering the flying object. A variety of avionics systems is used, each of which carries out different flight-relevant operating procedures in order to ensure safe operation of the flying object.

Such avionics systems, which are usually different from cabin systems, may be, for example, flight control and management systems (autopilot, flight management system, fly-by-wire control systems, collision warning systems such as TCAS etc.), communication systems (aeronautical communication systems), navigation systems (e.g. instrument landing systems such as ILS), display systems, sensor systems (such as radar systems) as well as internal (data) bus systems. Such avionics systems are characterized in that they electronically perform such flight-relevant operating procedures.

In order to minimize or reduce the amount of electronic equipment required for each flight-relevant operating procedure, multiple flight-relevant operating procedures are often carried out on one electronic computing device. Since the flight-relevant operating procedures may, in some circumstances, be critical to safety, it must be ensured that, in the event of a malfunction during the performance of a flight-relevant operating procedure, said malfunction does not have an adverse impact on the other flight-relevant operating procedures carried out on the electronic computing devices. If multiple computer programs (also referred to as applications) are run simultaneously or almost simultaneously on a data processing system, the processes in one application may influence the temporal behavior of another application. Particularly in the case of multi-core systems and/or multi-processor systems, i.e. systems where multiple processor cores and/or CPUs can run various programs in parallel at the same time, the use of shared resources (e.g. a shared RAM) can cause one application to slow down significantly due to another application. The literature refers to this phenomenon as multi-core interference.

Aviation systems have been pursuing the paradigm of Integrated Modular Avionics (IMA) for some time now. The aim is to run multiple applications on one computer. In contrast to this is the previously dominant approach of Federated Avionics (FA), where each application runs on its own computer. The advantages of IMA are obvious. By consolidating applications on one computer, weight and power consumption can be reduced since it enables greater utilization of the computers. In turn, this saves costs in both operation and development. The fundamental requirement for running multiple applications on one computer, however, is that they do not interfere with each other. Only when it is sufficiently ensured that multiple applications performed on one computer are isolated against one another can IMA be used for safety-critical systems in aviation.

In terms of this isolation, two dimensions are significant: temporal isolation and spatial isolation. Traditionally, temporal isolation has been achieved by the sequential performance of the various applications on one computer, enabling an almost simultaneous performance of various programs. Time slices of a fixed dimension have ensured that each application receives the necessary computing time on the processor.

However, the arrival of multi-core processors has meant an increase in the need to run different applications at the same time, in each case on a different processor core of the same data processing system (of the same computer). This, however, is a particularly long-overdue scenario for multi-core interference. The sequential running of the applications is still possible, but many applications, particularly safety-critical ones, are not easily scaled onto multiple processor cores, meaning that, effectively, the system then often uses just one processor core. However, the trend is moving towards more and more processor cores, i.e. the technological development is of no use to the use case in avionics.

Finally, it is desirable to consider applications on an individual basis with respect to approval. In the case of FA and IMA on one single-core processor, temporal and spatial isolation means that this is fundamentally not a problem and is known as incremental approval, which enables considerable savings in relation to approval costs. However, as soon as multiple applications are to be run simultaneously on different processor cores or, in the case of multi-CPU systems, simultaneously on multiple CPUs, complex analyses must show that multi-core interference and the resulting effects remain within a reasonable range.

An incremental approval, in which the applications can be considered completely independently of each other, is completely out of the question with this approach if at least one of the applications is a safety-critical application.

The subsequently published DE 10 2023 109 854.3 discloses an avionic computer for on-board flight operation in a flying object that can run computer programs on a computing unit. The computer programs have program code means which are provided at least partially as bytecode and are transcoded by a transcoder into runtime-related machine commands that are relevant for the computing unit.

The aim of the present invention is therefore to provide an improved method and an improved device for simultaneously running computer programs on a data processing system.

According to the invention, the task is solved using the method in accordance with claim 1. Advantageous embodiments of the invention are then to be found in the corresponding sub-claims.

According to claim 1, a method is proposed for running a plurality of computer programs on a data processing system which, according to the preamble, has at least two separate computing units that share a common resource of the data processing system. For example, such computing units may be cores of a multi-core processor. Such a computing unit can, however, also be a stand-alone CPU, the data processing system of which is a multi-CPU system. In this case, the data processing system is configured such that at least one computer program can be run on each computing unit, wherein the computing units are run in parallel. The computing units share at least one common resource of the data processing system, such as the RAM or hard drive.

It is intended that each computer program is run on one of the computing units of the data processing system using bytecode as a program code such that at least one computer program with bytecode as a program code can be run simultaneously on at least two computing units. To this end, the data processing system also has a transcoder that is configured to convert the program code means, provided as bytecode, of the respective computer program into the relevant machine commands for the respective computing unit. Accordingly, in the simplest embodiment a first computer program is run on a first computing unit and a second computer program, which is different to the first computer program, is run on a second computing unit, which is different to the first computing unit, wherein the first and the second computer programs are run in parallel to one another and the program code means of the first and second computer programs are provided as bytecode. The transcoder converts the bytecode of the first computer program into machine commands for the first computing unit and the bytecode of the second computer program into machine commands for the second computing unit.

Accordingly, the computer programs are implemented in bytecode, wherein this bytecode is then converted-with the aid of a transcoder-into the machine commands related to the runtime of the respective computer program that are relevant for the computing unit. The computer programs are thus not provided fully compiled and as pure machine commands for the specific target machine (computing unit), as is known from the prior art, but as bytecode from which the relevant runtime-related machine commands can be generated with the aid of the transcoder.

The bytecode therefore does not refer to machine commands for a specific computing unit, but an intermediate code that is first converted into the corresponding machine commands of the target machine with the aid of a transcoder run on the target machine. The transcoder is usually a computer program that is provided as machine code and can be run directly on the target machine, i.e. the machine code commands containing the transcoder can be directly performed by the target machine.

Since the complete status of the transcoder can be displayed in software and bytecode is universal, a running instance can also be easily migrated, as only the status of the transcoder and the actual bytecode of the application have to be copied to the target computer.

According to the invention, it is now provided for that for each computer program, the transcoder determines at least one interference value as a function of a number of transcoded machine commands per time step.

The interference value can be uniform for all computer programs, rendering the interference status of the overall data processing system visible. However, it is also conceivable that for each individual computer program, an individual interference value is determined from the number of converted machine commands per time step and per computing unit, rendering visible the current interactions of the interference on the respective computer program.

Such an interference occurs when two computer programs running in parallel on different computing units access a common resource and said resource is not suited to parallel access or is not configured or designed for it. At this moment, the running of the first computer program on the first computing unit is influenced by the use of the common resource by the second computer program on the second computing unit, which becomes clear by way of the interference value identified.

For example, if the number of machine commands per time step on the first computing unit and/or relating to the first computer program is significantly lower, while the number of machine commands per time step on the second computing unit and/or relating to the second computer program significantly increases, an interaction between the two computer programs can be assumed, even though they are running on separate computing units.

With the aid of the interference value identified in this way, it is possible to recognize problematic interactions between computing units and therefore make a negative interference between two computer programs on the two different computing units visible. This renders it possible to influence interactions with as little interference as possible in an appropriate control loop and/or to implement certification through incremental approval, even with multiple core processors.

With the aid of the present invention, a measure for the interference of at least two computer programs running in parallel on different computing units can be provided without having to adjust the computer programs to be run or having to provide corresponding hardware systems in order to measure the interference. As a result, both the target platform where the computer programs are to be run can remain unchanged, as can the computer programs to be run.

According to one embodiment, it is provided for that the transcoder converts the program code means by means of a code interpreter and/or by means of which just-in-time compiler into the relevant machine commands for the computing units.

According to one embodiment, it is intended that a transcoding module of the transcoder is allocated to each computer program, wherein the program code means of the allocated computer program, provided as bytecode, are converted into the relevant machine commands for the respective computing unit by the transcoding module allocated to the respective computer program.

According to one embodiment, it is intended that the running speed of at least one of the computer programs varies as a function of at least one identified interference value.

Accordingly, the running speed can be reduced for the computer programs that have a high output of machine commands per time step so as to increase the running speed for the benefit of the remaining computer programs. By reducing the throughput of machine commands per time step, the interference on the commonly utilized resource can be broken, meaning that the remaining computer programs have sufficient opportunities to access the common resource.

According to one embodiment, it is intended that the transcoder allocates a maximum number of machine commands to each computer program at the start of every time step that can be performed in that time step, wherein the transcoder stops the running of the computer program if the allocated maximum number of machine commands in the respective time step has been performed before the time steps ends.

For each computer program, a maximum number of machine commands is determined at the start of each time step. The performance of a machine command uses a certain proportion of this previously determined number. If the maximum number has been used up, i.e. the number of machine commands performed within a time step corresponds precisely to the maximum number, the further running of the computer program is interrupted. The start of a new time step then resets the maximum number of machine commands such that, per time step, the computer program can only ever perform the number of machine commands defined by the maximum number. The time steps on the individual computing units do not have to be synchronous, but they can also be synchronized.

According to one embodiment, it is provided that the interference value is identified as a function of a number of machine commands that have not been performed for the respective computer program by the end of the time step, or as a function of a number of machine commands that are replenished for the respective computer program at the start of the time step in order to reach the maximum number.

This allows the interference value to be calculated as a function of the remaining possible machine commands. If one computer program uses the maximum possible number of machine commands in each time step while another computer program does not utilize the maximum amount available to it, interference of these two computer programs can be assumed. Here, the interference value is determined to a degree that corresponds to the number of replenishments of machine commands per time unit.

According to one embodiment, it is intended that the maximum number of machine commands for each computer program is determined as a function of at least one identified interference value.

A control loop is defined as a result, by means of which the existing interference of two computer programs is influenced by, for example, reducing the running speed of the computer program that regularly reaches it maximum number of possible machine commands per time step prematurely (by reducing the maximum number per time step) while the running speed of the computer program that does not regularly exhaust its maximum number of machine commands per time step by a certain percentage is accelerated (by maintaining or increasing the maximum number per time unit).

According to one embodiment, it is provided that the data processing system is an avionic computer for on-board flight operation in a flying object, wherein each computer program is configured to carry out one flight-relevant operating procedure.

The avionic computer may comprise one or multiple input interfaces by means of which the avionic computer can be supplied with corresponding data from external sensors and/or bus systems. Furthermore, the avionic computer may comprise one or multiple output interfaces for outputting processed data onto a bus system and/or forwarding processed data to other actors and/or sensors. The avionic computer processes input data that has been received via the input interfaces and emits the result of the processing of the input data in the form of output data to connected elements, such as sensors or bus systems, via the output interfaces.

The avionic computer performs flight-relevant operating procedures, such as flight control systems, cockpit displays, flight management systems, cabin systems, weather and radar analyses etc. Accordingly, the term flight-relevant operating procedures refers to procedures that support the pilot, especially in flight, which can be performed on an electronic computing machine.

According to the invention, the task is also solved by way of the computer program according to claim 9, the computer program with program code means being configured to perform the method described above when the computer program is run on the data processing system. In particular, such a computer program is the transcoder in this case.

According to the invention, the task is also solved by way of the data processing system according to claim 10 that has at least two separate computing units which share a common resource of the data processing system, characterized in that the data processing system has a transcoder and is configured to carry out the method described above.

The invention is explained in more detail by means of the attached figures. They show:

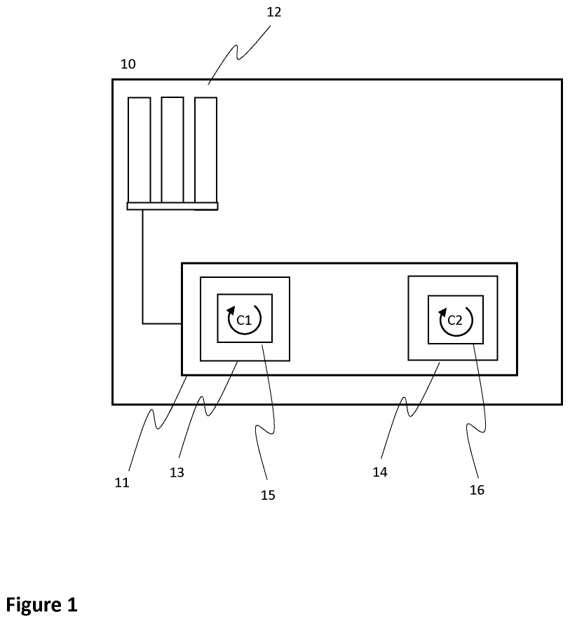

FIG. 1 a schematic view of a data processing system according to the present invention;

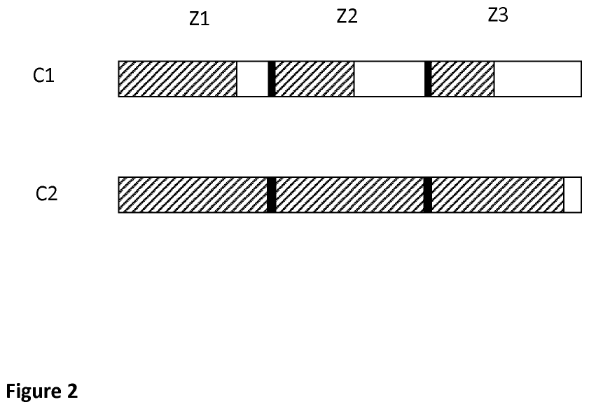

FIG. 2 diagram of performance in time steps.

FIG. 1 depicts a highly simplified schematic view of a data processing system 10 which can be, for example, an avionic computer. The data processing system 10 comprises a processor 11, which can perform corresponding instructions through performing machine commands. The processor 11 is connected to a volatile memory (RAM) 12 via an illustrated main board.

To enable parallel running, the processor 11 has two processor cores 13, 14 which, within the context of the present invention, are referred to as first computing unit 13 and second computing unit 14.

A first computer program C1 is run on the first computing unit 13, while a second computer program C2 is run on the second computing unit 14. The program code means of both the first computer programs C1 and the second computer program C2 are provided as bytecode and cannot be run natively in this form by the respective computing unit 13, 14.

A transcoder is provided for this purpose, which has a first transcoding module 15 and a second transcoding module 16. Accordingly, the first transcoding module 15 is run on the first computing unit 13 in order to convert the program code means of the first computer program C1, provided as bytecode, into machine commands for the first computing unit 13. The second transcoding module 16 is then run on the second computing unit 14 in order to convert the program code means of the second computer program C2, provided as bytecode, into machine commands for the second computing unit 14.

If both computer programs C1, C2 now access the common resource 12 (RAM) while running in parallel and simultaneously, it may lead to waiting times that prevent one of the computer programs from continuing to run.

For example, if the first computer program C1 excessively accesses the common resource 12, the second computer program C2 cannot take any data from the common memory 12. Accordingly, the second computer program C2 waits for the data from the memory 12, access to which is prevented by the running of the first computer program C1.

According to the invention, an interference value is continuously identified for each of the two computer programs C1, C2 that indicates the interference in relation to the common resource 12. This interference value is identified as a function of the machine commands performed per time step and may represent, for example, the ratio of machine commands performed within a time step.

FIG. 2 schematically depicts such a process. The running of each computer program is divided into time steps Z1, Z2 and Z3. Only three steps are depicted for the sake of clarity. In practice, there can be an almost infinite number of such time steps.

For each time step Z1, Z2 and Z3, each computer program C1, C2 is allocated a maximum number of machine commands that can be transcoded and performed by the transcoder within the respective time step.

FIG. 2 shows that in the first time step Z1 the first computer program C1 has used up its maximum number of machine commands before the time step is finished, which is indicated by the cross-hatched area. Conversely, the second computer program C2 has not used up its maximum number of machine commands in the first time step Z1.

Based on the first time step Z1, an interference value is identified from the ratio of machine commands per time step, from which it can be deduced that all machine commands of the first computer program C1 have been used up in this time step, while the second computer program C2 still has machine commands left over for this time step. As a result, an interference can be deduced to a common resource.

In order to counteract this, in the second time step Z2 the maximum number of machine commands for the first computer program C1 is reduced so that the machine commands available to the first computer program C1 have already been used up after half of the second time step Z2. This prevents the common resource from being blocked by the first computer program C1 in the remaining half of the second time step Z2 and therefore the second computer program C2 from gaining access. The interference value improves, wherein the second computer program C2 has still not performed all of the machine commands at its disposal.

For the third time step Z3, the maximum number of machine commands per time step for the first computer program C1 is once again reduced, meaning that for the second computer program C2 there is more time available for the common resource. It is now clear that in the third time step Z3, the second computer program C2 has also used up it maximum number of machine commands within the time step such that the interference is largely resolved.

In further time steps, one can now consider increasing the maximum number of machine commands for the first computer program C1 in order to find an optimum ratio. One can now also consider adjusting the maximum number of machine commands for the second computer program C2 in order to find a balanced ratio.

### REFERENCE LIST

10 data processing system
11 processor
12 common resource/memory
13 first computing unit
14 second computing unit
15 first transcoding module
16 second transcoding module
C1 first computer program
C2 second computer program
Z1 first time step
Z2 second time step
Z3 third time step

1. A method for running a plurality of computer programs on a data processing system that comprises a plurality of separate computing units which share a common resource of the data processing system, comprising:
running each computer program of the plurality of computer programs on separate computing units of the plurality of separate computing units of the data processing system using byte code as a program code means by
transcoding the program code means of the respective computer program provided as byte code into the relevant machine commands for the respective computing unit of the plurality computing units by a transcoder of the data processing system; and
using the transcoder to identify at least one interference value as a function of a number of transcoded machine commands per time step.

2. The method according to claim 1, wherein the transcoder converts the program code means by a code interpreter and/or by a just-in-time compiler into the relevant machine commands for the separate computing units.

3. The method according to claim 1, further comprising allocating a transcoding module of the transcoder is allocated to each computer program of the plurality of computer programs wherein the program code means of each allocated computer program provided as byte code are converted into the relevant machine commands for the respective computing unit of the plurality of computing units by the transcoding module allocated to the respective computer program of the plurality of computer programs.

4. The method according to claim 1, wherein a running speed of at least one of the computer programs of the plurality of computer programs varies as a function of at least one identified interference value.

5. The method according to claim 1, wherein the transcoder allocates a maximum number of machine commands to each computer program of the plurality of computer programs at the beginning of every time step that can be performed in that time step wherein the transcoder stops the running of the a computer program of the plurality of computer programs if the allocated maximum number of machine commands in the respective time step has been performed before the time step ends.

6. The method according to claim 5, wherein the interference value is identified as a function of a number of machine commands that have not been performed for the respective computer program of the plurality of computer programs by an end of a the time step, or as a function of a number of machine commands that are replenished for the respective computer program of the plurality of computer programs at a start of the time step in order to reach the maximum number.

7. The method according to claim 6, wherein a maximum number of machine commands for each computer program of the plurality of computer programs is determined as a function of at least one identified interference value.

8. The method according to claim 1, wherein the data processing system is an avionic computer for on-board flight operation in a flying object, and wherein each computer program of the plurality of computer programs is configured to carry out one flight-relevant operating procedure.

9. A computer program encoded on a non-transient storage medium with with program coding configured to carry out the method according to claim 1 when the computer program run on a data processing system.

10. A data processing system that has at least two separate computing units which share a common resource of the data processing system, wherein the data processing system has a transcoder and is configured to carry out the method according to claim 1.
